(19) United States
(12) Patent Application Publication
(10) Pub. No.: US 2019/0108647 A1
(43) Pub. Date: Apr. 11, 2019

(54) SYSTEMS AND METHODS FOR 3D CLUSTER RECOGNITION FOR RELATIVE TRACKING

(71) Applicant: THE BOEING COMPANY, Chicago, IL (US)

(72) Inventors: David K. Lee, Garden Grove, CA (US); Paul R. Davies, Long Beach, CA (US); David L. Caballero, Huntington Beach, CA (US)

(73) Assignee: THE BOEING COMPANY, Chicago, IL (US)

(21) Appl. No.: 15/728,961

(22) Filed: Oct. 10, 2017

(51) Int. Cl. G06T 7/521; G01S 17/66; G06K 9/62; G06T 7/11; G06T 7/73; G01S 17/42; G01S 7/48

(52) U.S. Cl. CPC G06T 7/521; G01S 17/66; G06K 9/6255; G06T 2207/10028; G06T 7/74; G01S 17/42; G01S 7/4804; G06T 7/11

(57) ABSTRACT

A system is provided that includes an array of reflectors, a detector, and a processing unit. The array of reflectors is configured to be disposed on an object. The detector acquires range information and intensity information corresponding to the reflectors. The processing unit is coupled to the detector, and is configured to acquire the range information and the intensity information from the detector; determine locations of the reflectors using the intensity information; correlate the locations of the reflectors with the range information to provide correlated locations; and identify the object using the correlated locations.

### FIELD OF EMBODIMENTS OF THE DISCLOSURE

Embodiments of the present disclosure generally relate to systems and methods for identifying individual elements of a 3-dimensional cluster to obtain relevant tracking information (e.g., location and/or pose of an object), using intensity and range information from a single detector.

### BACKGROUND OF THE DISCLOSURE

Various technologies, including augmented reality, utilize location and/or pose determinations for objects being analyzed. Augmented reality, for example, may provide real-time information for use with manufacturing, integration, assembly, maintenance, work instruction delivery, inspection, or the like. However, generating an augmented reality scene requires acquiring appropriate pose information for accurate spatial registration of virtual content. Current approaches generally have performance and/or cost drawbacks. For example, motion capturing has a generally high cost (depending on the number of cameras and/or tracking volume size), and does not provide convenient scale-ability. Further, motion capturing is susceptible to line-of-site factors and environmental factors, and is relatively difficult to use in confined spaces. Further still, tracking cameras used with motion capturing must remain at the same position and orientation relative to each other, with variations from the position or orientation causing degraded performance and/or requiring re-calibration. As another example, fiducial markers (e.g., use of predetermined 2D patterns and/or shapes) may utilize image processing techniques to recognize trained images and/or patterns. However, this approach has limited capability, including degraded performance as camera angles become severe. Fiducial marker approaches also are adversely affected by environmental factors, such as shadows, glare, or debris. As one more example, shape-based tracking may be employed. However, shape-based tracking may be computationally expensive. Further, an object must be in the field-of-view of a depth sensor to track the object. Further still, relatively large or fast translations or rotations may adversely affect performance of shape-based tracking.

### SUMMARY OF THE DISCLOSURE

Accordingly, improved object identification, for example, without requiring the use of multiple detectors and/or without requiring a fixed or predetermined detector position, is provided in various embodiments disclosed herein.

Certain embodiments of the present disclosure provide a system that includes an array of reflectors, a detector, and a processing unit. The array of reflectors is configured to be disposed on an object. The detector acquires range information and intensity information corresponding to the reflectors. The processing unit is coupled to the detector, and is configured to acquire the range information and the intensity information from the detector; determine locations of the reflectors using the intensity information; correlate the locations of the reflectors with the range information to provide correlated locations; and identify the object using the correlated locations.

Certain embodiments of the present disclosure provide a method. The method (e.g., a method for identifying an object) includes disposing an array of reflectors on the object. The method also includes acquiring, with a detector, range information and intensity information for the reflectors disposed in an array on the object. Further, the method includes determining locations of the reflectors using the intensity information. Also, the method includes correlating the locations of the reflectors with the range information to provide correlated locations, and identifying the object using the correlated locations.

### BRIEF DESCRIPTION OF THE DRAWINGS

FIG. 1 provides a schematic block diagram of an object identification system, according to an embodiment of the present disclosure.

FIG. 2 illustrates an example of an acquired intensity image.

FIG. 3 illustrates an example of an acquired range image.

FIG. 4 is a flowchart of a method, according to an embodiment of the present disclosure.

FIG. 5 is a block diagram of aircraft production and service methodology.

FIG. 6 is a schematic illustration of an aircraft.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Embodiments of the present disclosure provide systems and methods for identifying one or more objects (e.g., distinguishing objects from other objects, determining a position of an object, determining an orientation of an object) using intensity and range information obtained via a detector. In contrast to approaches that use a series of cameras returning one type of data, various embodiments use only a single detector that acquires 2 types of data, for example intensity information and range information. The intensity information may be 2-dimensional while the range information is 3-dimensional. Various embodiments provide for movability of the detector without requiring re-calibration of a system. Various embodiments utilize a reference frame defined with respect the sensor or detector, in contrast to approaches that utilize a global measurement that requires additional calculations to state the measurements relative to a user. In various embodiments, markers (e.g., reflectors) are placed in a physical scene (e.g., on one or more objects or portions thereof in an environment). The markers are placed relative to a known reference frame, and a database or catalog is compiled including the length between each marker and the other markers along with other relevant data. Data is then collected via a sensor that collects at least two different types of data over an imaging volume. For example, a sensor such as a Laser/Light Detection And Ranging (LADAR/LIDAR) sensor that collects both intensity information and range information may be utilized. The intensity information is used to detect portions of the imaging volume that potentially correspond to the markers. After marker locations are determined, the range information is used in conjunction with the determined marker locations to calculate a vector from the sensor to the each marker. The vectors may then be used to identify each detected marker within the database or catalog, providing information required to determine the relative position and/or orientation of the representative object.

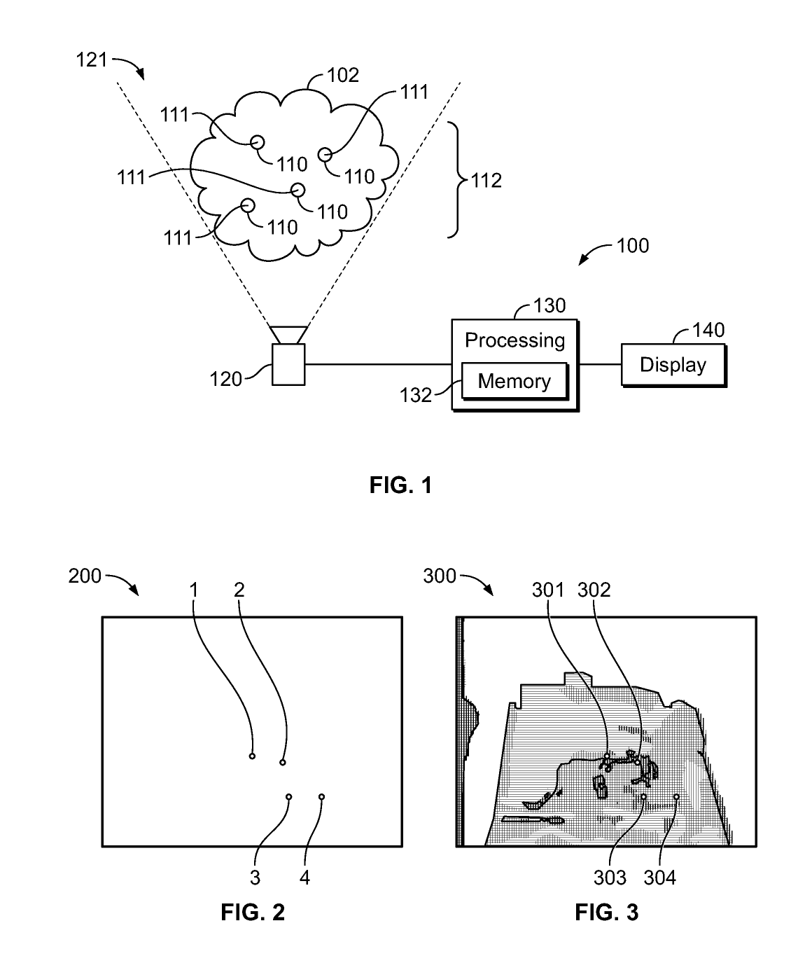

FIG. 1 provides a schematic view of a system 100. The system 100 is generally configured to identify one or more objects. Identification of an object, in various embodiments, may include one or more of identifying the particular object (e.g., distinguishing the object from one or more different objects), identifying a location of the object (e.g., in a predetermined coordinate system or relative to one or more other objects), or identifying an orientation or pose of an object. In the illustrated embodiment, only one object 102 is shown. However, it may be noted that more than one object may be utilized in various embodiments. Further, for example for an object including two or more articulable portions, the articulable portions may be separately identified (e.g., to determine an amount and/or orientation of articulation between the articulable portions).

The depicted system 100 includes reflectors 110, a detector 120, and a processing unit 130. Generally, the detector 120 senses information from the reflectors 110, which is used by the processing unit 130 to identify the object 102. For example, the processing unit 130 may be used to identify a location and pose or orientation of the object 102. The identified location and pose may be utilized, for example, as part of an augmented reality display. As another example, the identified location may be used in connection with docking of an aircraft or spacecraft.

As schematically depicted in FIG. 1, the reflectors 110 are arranged in an array 112 on the object 102. The reflectors are an example of a marker that may be disposed in an environment on an object. Four reflectors are shown in the illustrated embodiment; however, it may be noted that more or less reflectors may be used in various embodiments. The reflectors 110 include a reflective surface 111, and are configured to be disposed on the object 102. For example, the reflectors 110 may include a surface (e.g., opposite the reflective surface 111) that includes an adhesive for mounting to the object 102. As another example, the reflectors 110 may include one or more openings configured to allow the reflectors 110 to be secured to the object 102 with a fastener. As one more example, the reflectors 110 may include one or more mounting features configured to cooperate with corresponding features of the object 102 to mount the reflectors 110 to the object 102.

The reflectors 110 may be configured in one or more shapes. For example, the reflectors 110 may have a hemispherical shape, with the curved portion forming the reflective surface 111, and the flat surface configured for mounting to the object 102. A reflector 110 having a hemispherical shape will generally reflect a circular pattern of light or other wave (e.g., infrared (IR)) regardless of the angle from which the light or other wave impacts the reflector 110. Other shapes may be used additionally or alternatively. For example, different sizes and/or shapes of reflectors may be used on different objects, with each object having a unique size and/or shape of reflector for conveniently distinguishing between different objects based on reflector size and/or shape. As another example, different reflectors on the same object may have different sizes or shapes for distinguishing between particular reflectors. It may be noted that in various embodiments, uniformly sized and shaped reflectors may be employed.

The reflective surface 111 is generally configured to reflect light or other wavelength for detection by the detector 120. For example, the reflective surface 111 may be formed by applying a reflective tape to the detector 120. As another example, a reflective paint or coating may be applied. Generally, the reflective surface 111 is more reflective than the outer surface of the object 102 to which it is attached to help distinguish the reflector 110 from the object 102 using information acquired via the detector 120.

The reflectors 110 are disposed on the object 102 in the array 112. The array 112 may be predetermined, with the reflectors 110 mounted at predetermined mounting points that provide a known distance and angular or positional relationship between the various reflectors 110. Alternatively, the reflectors 110 may be mounted to the object, with the distances and angular or positional relationships between the reflectors 110 measured after mounting to the object 102. The distances between the reflectors 110, along with the angular positional relationships between the reflectors 110 in various embodiments is compiled for use as a catalog by the processing unit 130, so that various reflective portions of acquired images may be correlated to particular reflectors 110 in the array 112, which may then be used to determine the location and/or pose of the object 102 to which the reflectors 110 are mounted. For embodiments using differently sized or shaped reflectors, that information may also be catalogued and used to identify particular reflectors in acquired images.

It may be noted that in various embodiments, the reflectors are disposed at irregular distance relative to each other in the array. For example, each reflector pair may have a unique distance therebetween, so that individual reflectors may be identified based on the distance of the particular reflector to one or more other reflectors. Further, it may be noted that a uniform array, such as an equilateral triangle, may appear the same when viewed at different viewing angles. However, by having the reflectors distributed non-uniformly or non-homogenously, the array appears differently based on viewing angle, allowing for more convenient determination of viewing angle.

The detector 120 acquires range information and intensity information over an imaging volume 121. The range information and intensity information includes information corresponding to the reflectors 110. The intensity information in various embodiments includes information corresponding to brightness or signal intensity within the imaging volume 121. The range information in various embodiments includes information corresponding to the distance of detected portions within the imaging volume 121 to the detector 120. The intensity information may be acquired as part of a 2D image. An example of intensity information as acquired by the detector 120 is depicted as intensity image 200 in FIG. 2. Generally, portions of the image corresponding to the reflectors 110 will appear brighter or have a stronger intensity than other portions. As discussed herein, thresholding and/or use of a shape filter may be employed to distinguish between portions of the intensity image 200 that correspond to reflector locations and portions of the intensity image 200 that do not. An example of range information as acquired by the detector 120 is depicted as range image 300 in FIG. 3. In the illustrated embodiment, the intensity information is used to detect the reflectors, and the range information (in coordination with the intensity information) is used to calculate a vector from the sensor to each detected reflector.

Generally, the depicted detector 120 is configured to acquire both range information and intensity information, which may be represented in separate images as shown in FIGS. 2 and 3. By way of example, flash or scanning LADAR/LIDAR sensors, or structure light senor such as Kinect™, or Xtion™ sensors may be used with the detector 120. It may be noted that in various embodiments, in contrast to certain motion tracking approaches (e.g., approaches that use multiple cameras to acquire one type of data), only a single detector 120 may be used by the system 100. Further, the position of the detector 120 relative to the object 102 and/or the reflectors 110 in various embodiments need not be predetermined. Accordingly, the detector 120 may be mobile. For example the detector 120 may be worn as part of a headset. It may be noted, however, that the detector 120 may be stationary in various embodiments.

The processing unit 130 is coupled to the detector 120, and acquires the intensity information and the range information from the detector 120. The depicted processing unit 130 is also coupled to a display 140, and configured to provide output information to the display 140 to convey an image (e.g., to an operator using the system 100). The processing unit 130 includes a memory 132 that stores instructions for directing the processing unit 130, for example, to perform tasks, processes, or flowcharts discussed herein (or aspects thereof). Accordingly, the processing unit 130 may be understood as being specifically configured to or programmed to perform tasks, processes, or flowcharts discussed herein (or aspects thereof). The memory 132 in various embodiments also stores the information cataloging the information regarding the reflectors (e.g., distance between).

Generally, the processing unit 130 uses information acquired via the detector to identify the object 102. Identifying the object 102 in various embodiments may include one or more of distinguishing the object 102 from other objects, determining a location of the object 102, or determining an orientation or pose of the object 102. The processing unit 130 may also compare the location and/or position of the object 102 with respect to a desired or target location or position (e.g., as part of an augmented reality display, and/or for docking an aircraft or spacecraft).

The depicted processing unit 130 is configured to (or programmed to) acquire the range information and the intensity information from the detector, determine locations of the reflectors 110 using the intensity information, correlate the locations of the reflectors 110 (as determined using the intensity information) with the range information to provide correlated locations, and to identify the object using the correlated locations. For example, an initial detection of reflectors may be performed using the intensity information. As the reflectors 110 are generally brighter than other objects in the intensity image 200, the intensity information may be thresholded to create a binary image. The threshold value in various embodiments is a predetermined or pre-calculated value based on the reflective material used for the reflectors 110 and expected sensor performance. Alternatively, an adaptive frame-to-frame thresholding value may be employed (e.g., selecting a top percentage range of pixels in terms of intensity level). Other thresholding schemes may be employed in various embodiments. Those pixels that satisfy the threshold are set to 1, those that do not are set to 0.

It may be noted that thresholding may result in false positives in various embodiments. Accordingly, a shape filtering or other analysis may be performed by the processing unit 130 on the intensity information to detect the locations of the detectors. For example, after a successful initial thresholding is performed, the majority of the intensity image is removed leaving primarily reflectors or targets of interest in the intensity image. Next, the remaining pixels having a value of 1 may be analyzed to separate reflectors from non-target pixels. The pixels may be organized into groups of adjacent pixels. The size of the groups of pixels having a value of 1 may be used to remove false positives. Depending on the resolution of the intensity information, knowledge of the optics of the detector 120, and geometric data of the reflectors 110, a threshold on the number of pixels in each group may be employed. For example, pixel groups having a size too small or too large to correspond to the expected size may be removed. As another example, a shape filter may be employed, and pixel groups that do not correspond to an expected shape may be removed. For instance, for hemispherical reflectors, a circular shape is expected. Those groups of pixels that substantially differ from a circular shape may be removed. In various embodiments, the processing unit 130 may determine a centroid for each detect (e.g., pixel group) that passed the various thresholds and/or filters, and use each centroid as a 2D location for each reflector 110 on the image 200. As seen in FIG. 2, for the illustrated embodiment, there are four reflectors for which a location has been determined, identified as 1, 2, 3, and 4 on FIG. 2. Each reflector may be defined, for example, by a corresponding pixel group that satisfied one or more of a shape or size filter, with the centroid of each pixel group used to determine distance between the pixel groups or corresponding reflectors.

For example, the processing unit 130 may provide the correlated locations by first determining corresponding vectors to each reflector 110 from the detector 120 using both the intensity information and the range information to provide a corresponding position (e.g., distance from detector 120 and angle from detector 120) for each reflector 110. The processing unit 130 may then use the determined vector information to calculate a distance and angel between each pair of reflectors. In other words, for each reflector 110, the processing unit may calculate a corresponding distance and angle between that particular reflector 110 and each other reflector 110. Next, the processing unit 130 may correlate the positions of the reflectors 110 (as determined using the vector information) to a catalog of predetermined reflector entries. Based on the predetermined locations of the reflectors 110 with respect to each other, in some embodiments, the processing unit 130 may then determine the locations or positions of particular reflectors, and, using the determined reflector positions, may determine a pose for the object 102 using the determined positions of the reflectors 110.

Various example aspects of identifying an object using correlated intensity information and range information employed in various embodiments will now be discussed. With reference to FIGS. 2 and 3, once the target detection phase (e.g., identification of reflector locations using thresholding and/or filtering on the intensity information) is complete, with 2D locations of the reflectors 110 calculated, the determined locations based off of the intensity information are correlated with corresponding range information. As seen in FIGS. 2 and 3, the four reflector locations 1, 2, 3, 4 of the intensity image 200 correspond with locations 301, 302, 303, and 304 of the range image 300, respectively. Accordingly, each detected 2D position may be used to find a corresponding range (e.g., range to detector 120) in the range image 300. The determined ranges may then be used to provide a corresponding vector from the detector 120 to each reflector 110.

With a corresponding vector from the detector 120 to each reflector 110 determined, the vectors may be used to calculate the distances between each of the reflectors 110 relative to the others. The length between the reflectors 110 may be used to determine the identity of the particular reflector 110 corresponding to each location detected via the intensity information. For example, the distance between the first reflector location 1 and all other detected reflector locations (2, 3, 4) may be calculated and compared with the cataloged distances between the reflectors to identify individual reflectors. Additionally, other information may be used to determine the location or position of particular reflectors. For example, the angle formed between each detected reflector location and one or more other detected reflector locations may be compared with cataloged information to identify particular reflectors. It may be noted that as the number of reflectors increases, the number of comparisons increases. In some embodiments, instead of being stored as single entries, databases may be configured as overlapping clusters using a length discriminator (based on distance between reflectors) to reduce the number of comparisons required.

It may be noted that, in various embodiments, different algorithms or techniques may be utilized for identification of particular reflectors and/or particular objects based on the reflector locations. Generally, in various embodiments, intensity and range information from a single sensor (e.g., detector 120) is used, without any prior information or estimate regarding the relative position or orientation of the sensor with respect to the reflectors and/or object on which the reflectors are disposed.

In some embodiments, for example embodiments having moderately sized catalogs, the following approach may be employed. First, the catalog is sorted by distance between the catalog targets (e.g., for each cataloged reflector, a distance between that particular reflector and each other cataloged reflector. Next, the measurements are sorted by distance between the detected targets (e.g., distance between centroids of pixel groups that remained after thresholding and/or filtering of the intensity image 200). It may be noted that there may be more or less detects (e.g. detections) than cataloged entries. If the detects have more or less occurrences than cataloged entries, the error may be minimized, and, if a unique solution is found, the detects and catalog entries may be correlated. If not, there may be false detects which may be identified and filtered out. For example, all distance and endpoint pairs that conflict or do not lead to a unique solution may be removed, and the error recalculated. Further, if enough distance and endpoint pairs are removed that the number of detects is less than the number of cataloged entries, removed pairs may be added back and the error re-calculated, with the targets that minimize error considered for being added back to the group of detected locations.

As another example, in some embodiments, for example, embodiments having smaller sized catalogs, the following approach may be employed. First, the distance between all detected targets may be compared with values from the catalog, minimizing error. Then, the distances may be compared to corresponding values from the catalog in all combinations, and minimized. The combination that minimizes the absolute error may be used as the final configuration. It may be noted that correct identification may be increased by using triplets (instead of pairs), with the angles between segments of triplets also used to identify locations of particular reflectors. It may further be noted, however, that the use of triplets increases computational resources relative to the use of pairs.

As another example, in some embodiments, for example, embodiments having larger sized catalogs, the following approach may be employed. The distance between all detected reflectors may be calculated, and sorted in descending order, keeping track of endpoints for all segments defined between detected reflector pairs. The largest detected segment may then be compared to the largest cataloged segment. The distances and/or angles between the largest detected segment and other segments may be compared with corresponding results for the cataloged entries, and if the comparisons satisfy a predetermined threshold or criterion, the detected segment may identified as the cataloged segment. If not, the next largest detected segment may be analyzed. The process may be repeated until a match is found or all detected locations have been tested. Next, the process may move on to the next longest cataloged segment from either endpoint of the previously identified segment. Generally, this approach minimizes or reduces the comparisons required to uniquely identify all (or some minimum number) of detected locations. Instead of comparing all catalog entries to all detected entries in all combinations, a discriminating feature (e.g., distance between detected locations and/or angle between segments) to identify one detected location at a time.

In various embodiments, after all detected reflector locations are identified and correlated with their corresponding respective catalog entries, the determined information may be used to determine or estimate the pose or orientation of the object. Generally, once the particular locations of each reflector 110 within the array 112 (or a sufficient number of reflectors 110) is known, those locations may be used, along with the known locations of each particular reflector 110 on the object 102, to determine the location and pose or orientation of the object 102.

Further still it may be noted that the processing unit 130 may use the determined vectors between the detector 120 and the reflectors 110 to determine the position of the detector 120 relative to the reflectors 110 and/or the object 102 on which the reflectors 110 are disposed. When the detector 120 is worn by a user, or is an otherwise predetermined relationship with the user, the position of the user relative to the object 102 may accordingly be determined as well.

The depicted embodiment also includes a display unit 140. Generally, the display unit 140 receives information from the processing unit 130 regarding the determined location and/or pose of the object 102 (and/or any other objects identified by the processing unit 130) and provides a corresponding display (e.g., via a display screen) to a user or operator of the system 100. For example, the system 100 may provide augmented reality displays, with the object 102 displayed relative to a virtual target. Generally, as used herein, augmented reality displays may be understood as adding digital content to acquired images. For example, the determined position and orientation of the object 102 (as determined by the processing unit 130) may be displayed along with digital content. The digital content, may include, for example, a desired ending pose and/or location for the object 102. The operator may then manipulate the object 102 until the object 102 matches or corresponds to the desired ending pose as shown by the augmented reality display. For example, a user installing a wire or conduit in an environment (e.g., aircraft) may view a display featuring a virtual desired layout for the wire or conduit. Based on images provided by the system 100 of the actual wire or conduit being installed, the user may match the acquired images to the virtual desired layout. In various embodiments, the display unit 140 and the detector 120 both may be part of a headset worn by a user, for example with the display unit 140 positioned within a line of sight of the user when wearing the headset.

As another example, the system 100 may be used in connection with docking of aircraft or spacecraft, for example in connection with autonomous docking at space stations or between spacecraft. For example, LIDAR may be employed in connection with reflectors disposed on spacecraft for docking.

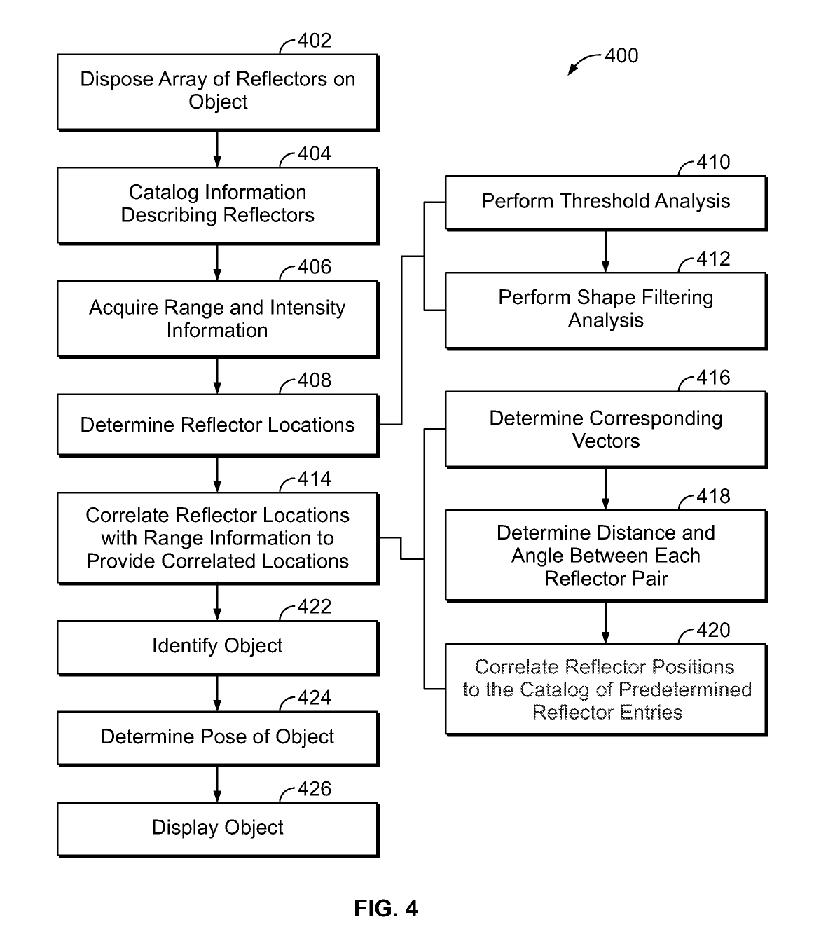

FIG. 4 provides a flowchart of a method 400 for directing or aiming light energy (e.g., a laser), in accordance with various embodiments. The method 400, for example, may employ or be performed by structures or aspects of various embodiments (e.g., systems and/or methods and/or process flows) discussed herein. One or more aspects of the method 400 may correspond to steps or tasks performed by a processing unit (e.g., processing unit 130). For example, the processing unit 130 may be programmed to perform one or more aspects of the method 400. In various embodiments, certain steps may be omitted or added, certain steps may be combined, certain steps may be performed concurrently, certain steps may be split into multiple steps, or certain steps may be performed in a different order.

At 402, an array of reflectors (e.g., reflectors 110) is disposed on an object (e.g., object 102). Generally, the reflectors are configured to reflect light and/or other waves for detection and subsequent determination of the positions of the reflectors. It may be noted that, while one object is discussed in connection with various embodiments described herein, more than one array of reflectors may be employed and more than one object analyzed. For example, a separate array may be placed on each rigid body for which a position and/or orientation are desired to be determined. In various embodiments, the reflectors are disposed on the object at irregular distances from each other. For instance, where each reflector is disposed at a unique distance to one or more other detectors, the unique distance may be used to simplify reflector identification. Further, homogenous distributions (such as a square pattern or equilateral triangle) may appear the same from different viewing angle. Accordingly, placing the reflectors at irregular distances improves the ease of determining a viewing angle to the array of reflectors.

At 404, information describing the reflectors is cataloged. For example, the distance from each particular reflector to each other reflector may be cataloged. As another example, angular relationships between reflectors may be cataloged. Further still, additional information, such as size and/or shape of reflector may be cataloged or tabulated for each reflector. A group of cataloged information describing the reflectors attached to a given object may be cataloged for each object to be analyzed. The spatial relationship between each reflector may be fixed or predetermined for an array, with the reflectors in fixed relationship to each other and the array mounted in a fixed, predetermined orientation and location with respect to the object on which the array is mounted. Additionally or alternatively, the positions of the reflectors relative to each other and/or to the object on which they are mounted (e.g., to a landmark or predetermined location on the object) may be measured or determined after mounting the reflectors to the object.

At 406, range information and intensity information is acquired with a detector (e.g., detector 120). The range information and intensity information includes information corresponding to the reflectors disposed in the array on the object. Generally speaking, the intensity information may be 2-dimensional in nature and describes or corresponds to the level or strength of intensity for the portions of an environment including the object that are within a field of view of the detector. The range information is 3-dimensional in nature and corresponds to the distance from the detector of the portions of an environment including the object that are within a field of view of the detector. It may be noted that in various embodiments the intensity and range information are acquired by the same detector and accordingly are conveniently spatially registered to each other. It may be noted that in some embodiments, only a single detector is used to acquire the range information and intensity information. Further, in various embodiments, the position of the detector need not be known before determining the position of the reflectors and/or the object on which the reflectors are disposed. Further still, the detector may be mobile (e.g., worn as part of a headset or otherwise moved by a user).

At 408, locations of the reflectors are determined using the intensity information. Generally, the reflectors may be distinguished from other portions of the object and/or background in the acquired intensity information by one or more of the level of intensity of signal, the shape of pixel groups (groups of pixels formed by adjacent pixels) having a given intensity, and/or the size of pixel groups having a given intensity. For example, in the illustrated embodiment, at 410, a threshold analysis is performed on the intensity information to detect the locations of the reflectors. For instance, all pixels having an intensity above a predetermined threshold may be identified as potentially corresponding to a reflector, with the predetermined threshold based on reflective material used and sensor characteristics. At 412 of the illustrated embodiment, a shape filtering analysis is performed on the intensity information. For example, all pixels satisfying the threshold at 410 may be set to 1, with the remaining pixels set to 0. Then, all pixels having a value of 1 may be separated into groups of adjacent pixels, with the shape of the groups compared to an expected shape of reflector signal (e.g., hemispherical reflectors have an expected circular signal shape) to determine which groups correspond to reflectors and which groups are false positives. Additionally or alternatively, the size of the groups may be used to determine which groups correspond to reflectors and which groups are false positives.

At 414, after the locations of the reflectors have been determined using the intensity information, the locations of the reflectors are correlated with the range information to provide correlated locations. It may be noted that the locations determined solely with the intensity information may be 2-dimensional in nature; however, after correlation with the 3-dimensional range information, the correlated locations are 3-dimensional in nature. For example, the correlated information may include both distance and angle from a given location (e.g., from the detector and/or a user associated with the detector).

In the illustrated embodiment, the correlation of the intensity and range information to correlate determined reflector locations with range information, or to determine correlated locations for the reflectors using the range information, may be performed in a series of steps. For instance, at 416, corresponding vectors to each reflector from the detector are determined using the intensity information and the range information to provide a corresponding position for each reflector. The position for a given detected reflector may be expressed as a vector having an angle from the detector to the particular reflector and a magnitude corresponding to the distance from the particular reflector to the detector. At 418, using the vectors determined for the various reflectors, the distance and angle between each pair of reflectors is determined. For example, knowing the distance and angle between the reflectors and the detector, as provided by the determined vectors, the distance and angle between a given reflector and the other reflectors may be determined. At 420, the positions of the reflectors are correlated to the catalog of predetermined reflector entries (e.g., in a catalog as provided at 404). For example, if, based on the catalog entries, it is known that a unique distance and angular relationship exists between two given reflectors, a matching distance and angular relationship of two detected reflectors may be used to identify the given reflectors. Accordingly, by using the distances and angles between the various reflector pairs, the reflectors may be correlated to the cataloged data and the position of each particular reflector determined.

At 422, the object is identified using the correlated locations of the reflectors. With the spatial relationship of the array of detectors to the object known a priori, once the location of each reflector is determined, the position and location of the array may be determined, and accordingly the position and location of the object may be determined, as well as the orientation of the object, based on the determined reflector positions and the knowledge of the spatial relationship between the reflectors and the object. Identification of the object in various embodiments includes one or more of distinguishing the object from other objects, identifying a location of the object, or identifying an orientation of the object. For example, at 424, a pose (position and orientation) of the object is determined. Further, the position of the detector relative to the locations of the reflectors (and/or the object on which the reflectors are positioned) may be determined based on the determined vectors.

At 426, the object is displayed. For example, the object may be displayed relative to a virtual target. For instance, the object may be displayed as part of an augmented reality display, with a desired position and orientation of the object added as virtual content to an image including the measured or determined position and orientation of the object. An operator viewing the display may then manipulate the object, and, as the new position and orientation is determined and displayed, continue manipulating the object and comparing the resulting image to the virtual displayed position and orientation until a satisfactory match is achieved. The displayed digital content added to the measured or determined image may also include, for example, work instructions related to the manipulation of the object.

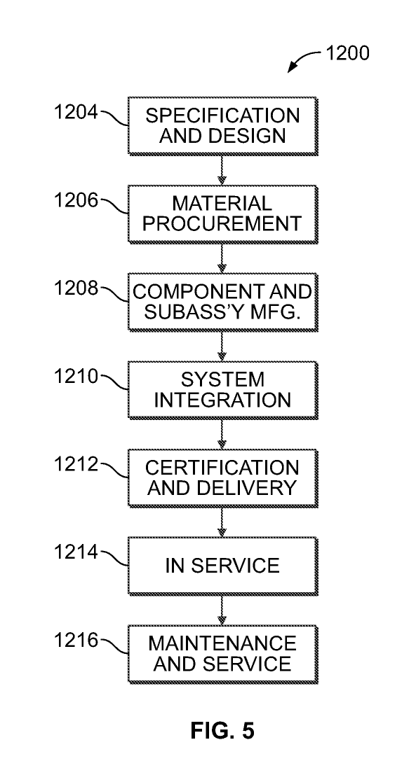

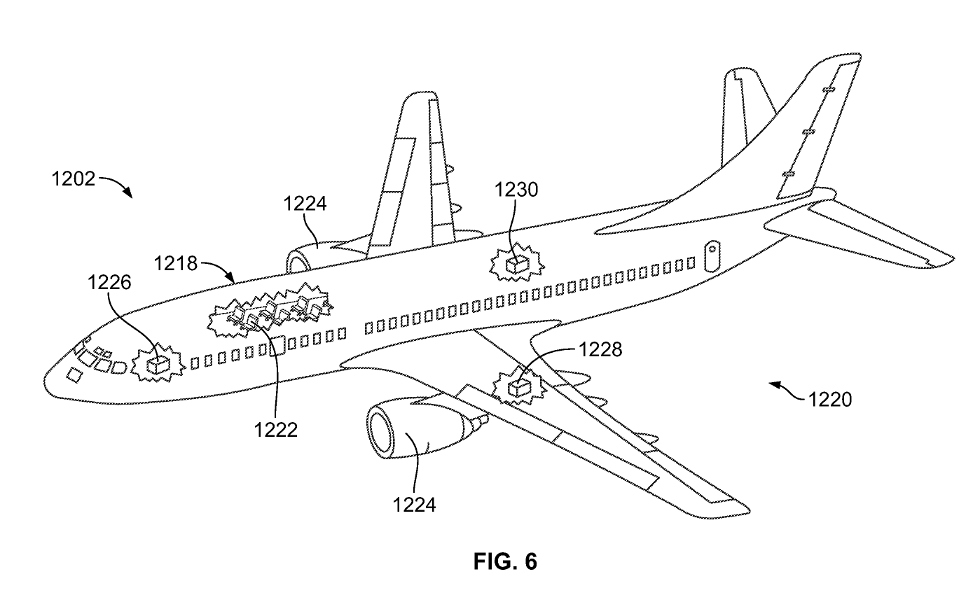

Examples of the present disclosure may be described in the context of aircraft manufacturing and service method 1200 as shown in FIG. 5 and aircraft 1202 as shown in FIG. 6. During pre-production, illustrative method 1200 may include specification and design (block 1204) of aircraft 1202 and material procurement (block 1206). During production, component and subassembly manufacturing (block 1208) and system integration (block 1210) of aircraft 1202 may take place. Thereafter, aircraft 1202 may go through certification and delivery (block 1212) to be placed in service (block 1214). While in service, aircraft 1202 may be scheduled for routine maintenance and service (block 1216). Routine maintenance and service may include modification, reconfiguration, refurbishment, etc. of one or more systems of aircraft 1202. For example, in various embodiments, examples of the present disclosure may be used in conjunction with one or more of blocks 1208, 1210, or 1216.

Each of the processes of illustrative method 1200 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

As shown in FIG. 6, aircraft 1202 produced by illustrative method 1200 may include airframe 1218 with a plurality of high-level systems 1220 and interior 1222. Examples of high-level systems 1220 include one or more of propulsion system 1224, electrical system 1226, hydraulic system 1228, and environmental system 1230. Any number of other systems may be included. Although an aerospace example is shown, the principles disclosed herein may be applied to other industries, such as the automotive industry. Accordingly, in addition to aircraft 1202, the principles disclosed herein may apply to other vehicles, e.g., land vehicles, marine vehicles, space vehicles, etc. In various embodiments, examples of the present disclosure may be used in conjunction with one or more of airframe 1218 or interior 1222.

Apparatus(es) and method(s) shown or described herein may be employed during any one or more of the stages of the manufacturing and service method 1200. For example, components or subassemblies corresponding to component and subassembly manufacturing 1208 may be fabricated or manufactured in a manner similar to components or subassemblies produced while aircraft 1202 is in service. Also, one or more examples of the apparatus(es), method(s), or combination thereof may be utilized during production stages 1208 and 1210, for example, by substantially expediting assembly of or reducing the cost of aircraft 1202. Similarly, one or more examples of the apparatus or method realizations, or a combination thereof, may be utilized, for example and without limitation, while aircraft 1202 is in service, e.g., maintenance and service stage (block 1216).

Different examples of the apparatus(es) and method(s) disclosed herein include a variety of components, features, and functionalities. It should be understood that the various examples of the apparatus(es) and method(s) disclosed herein may include any of the components, features, and functionalities of any of the other examples of the apparatus(es) and method(s) disclosed herein in any combination, and all of such possibilities are intended to be within the spirit and scope of the present disclosure.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
an array of reflectors configured to be disposed on an object;
a detector that acquires range information and intensity information corresponding to the reflectors; and
a processing unit coupled to the detector, the processing unit configured to:
acquire the range information and the intensity information from the detector;
determine locations of the reflectors using the intensity information;
correlate the locations of the reflectors with the range information to provide correlated locations; and
identify the object using the correlated locations.

2. The system of claim 1, wherein the processing unit is further configured to determine corresponding vectors to each reflector from the detector using the intensity information and the range information to provide a corresponding position for each reflector.

3. The system of claim 2, wherein the processing unit is further configured to calculate a distance and an angle between each pair of reflectors.

4. The system of claim 3, wherein the processing unit is further configured to correlate the positions of the reflectors to a catalog of predetermined reflector entries.

5. The system of claim 4, wherein the processing units is configured to determine a pose for the object using the locations of the reflectors.

6. The system of claim 1, further comprising a display unit, wherein the processing unit is configured to display the object relative to a virtual target.

7. The system of claim 1, wherein only one detector is used to acquire the range information and the intensity information.

8. The system of claim 1, wherein the processing unit is further configured to identify a position of the detector relative to the locations of the reflectors.

9. The system of claim 1, wherein the reflectors are disposed at irregular distances relative to each other in the array.

10. The system of claim 1, wherein the processing unit is configured to perform a threshold analysis on the intensity information to detect the locations of the detectors.

11. The system of claim 1, wherein the processing unit is configured to perform a shape filtering analysis on the intensity information to detect the locations of the detectors.

12. A method for identifying an object comprising:
disposing an array of reflectors on the object;
acquiring, with a detector, range information and intensity information for the reflectors disposed in an array on the object;
determining locations of the reflectors using the intensity information;
correlating the locations of the reflectors with the range information to provide correlated locations; and
identifying the object using the correlated locations.

13. The method of claim 12, wherein correlating the locations of the reflectors with the range information comprises determining corresponding vectors to each reflector from the detector using the intensity information and the range information to provide a corresponding position for each reflector.

14. The method of claim 13, further comprising determining a distance and an angle between each pair of reflectors.

15. The method of claim 14, further comprising correlating the positions of the reflectors to a catalog of predetermined reflector entries.

16. The method of claim 15, further comprising determining a pose for the object using the locations of the reflectors.

17. The method of claim 12, further comprising displaying the object relative to a virtual target.

18. The method of claim 12, wherein only one detector is used to acquire the range information and the intensity information.

19. The method of claim 12, further comprising identifying a position of the detector relative to the locations of the reflectors.

20. The method of claim 12, wherein disposing the reflectors on the object comprises disposing the reflectors at irregular distances relative to each other in the array.
